(19) United States
(12) Patent Application Publication
(10) Pub. No.: US 2009/0115622 A1
(43) Pub. Date: May 7, 2009

(54) METHOD OF DETERMINING AND MONITORING A DISTANCE TRAVELLED BY A MARINE VESSEL CONNECTED TO ANCHOR

(76) Inventors: Brian Edward Michie, Westmere (NZ); Brue John Wilson, Ellerslie (NZ)

Correspondence Address: Charles N.J. Ruggiero;Ohlandt, Greeley, Ruggiero & Perle, L.L.P., 10th Floor, One Landmark Square, Stamford, CT, 06901-2682, US

(21) Appl. No.: 12/254,596

(22) Filed: Oct. 20, 2008

(30) Foreign Application Priority Data
Oct. 26, 2007 (NZ) 562819

(51) Int. Cl. G08B 21/00

(52) U.S. Cl. 340/686.1

(57) ABSTRACT

A method is disclosed for monitoring the position of a floating object. The method starts by receiving as input at least a position of the floating object, and an orientation of the floating object. A horizontal distance between the floating object and an anchor coupled to the floating object is then calculated. A position of the anchor is then calculated from the position of the floating object and the orientation. An area is set based upon the position of the anchor, and it is determined whether a present position of the floating object is within that area. An alarm signal is provided when the present position of the floating object is outside the area.

### STATEMENT OF CORRESPONDING APPLICATIONS

This application is based on the Provisional specification filed in relation to New Zealand Patent Application Number 562819, the entire contents of which are incorporated herein by reference

### TECHNICAL FIELD

This invention relates to a method of determining and monitoring a distance traveled by a marine vessel connected to an anchor, and in particular, though not solely, to a method of alerting the vessel operator through an alarm which indicates the breaking loose or slippage of an anchor.

### BACKGROUND

Marine vessels, for a variety of reasons, moor by means of an anchor and a rode (the cable, chain and/or rope connecting the vessel to its anchor). It is common for a moored vessel to drift from their position when its anchor breaks loose or slips. This can be a result of a number of factors including: changed tide and wind conditions; poor ground holding; inadequate anchor design; inadequate rode design; anchor or rode failure; and poor seamanship. The consequences of a moored vessel inadvertently moving from its intended position can be catastrophic, with a potential for loss of the vessel and loss of life.

Over the years a large number of anchor monitoring systems have been developed to indicate that a moored marine vessel may have drifted from its intended position. Recently these systems involve the use of a Global Positioning System (GPS) whereby an alarm warns the vessel operator when the vessel moves beyond a predetermined distance from an initial position of the vessel. In particular, the initial position is determined using the GPS and a circular ‘safe’ zone is created around that initial position. When the anchor monitoring systems determines that the vessel is no longer positioned within the safe zone, an alarm sounds informing the operator that the vessel has drifted from its intended position.

However, the above described anchor monitoring systems are limited in application. In tight locations, the circular safe zone has to be decreased, which in turn results in frequent false alarms as the vessel swings around its anchor due to wind and tide changes.

It is an object of the present invention to address the foregoing problems or at least to provide the public with a useful choice.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

Further aspects and advantages of the present invention will become apparent from the ensuing description which is given by way of example only.

### DISCLOSURE OF INVENTION

It is an object of the present invention to provide an improved method of determining and monitoring when a marine vessel has drifted from its intended position.

Accordingly to a first aspect the invention there is provided a method of monitoring the position of a floating object, said method comprising the steps of:

i) receiving as input at least a position of said floating object, and an orientation of said floating object;

ii) calculating a horizontal distance between said floating object and an anchor, said anchor being coupled to said floating object;

iii) calculating a position of said anchor from said position of said floating object and said orientation;

iv) setting an area based upon said position of said anchor;

v) determining whether a present position of said floating object is within said area; and

vi) providing an alarm signal when said present position of said floating object is outside said area.

Preferably said position of said floating object and said signal present position of said floating object are determined by means of a positioning system.

Preferably said horizontal distance between said floating object and said anchor is determined from rode length and water depth inputs.

Preferably said orientation is determined from at least a compass signal.

Preferably said area is a circular area with the center of said area being defined by said position of said anchor.

According to another aspect of the invention there is provided an apparatus for implementing the above method.

According to yet another aspect there is provided a computer readable medium, having recorded thereon a computer executable program for implementing the above method.

Other aspects of the invention are also described.

### BRIEF DESCRIPTION OF DRAWINGS

Aspects of the prior art and one or more embodiments of the present invention will now be described with reference to the accompanying drawings, in which:

FIG. 1 illustrates a marine vessel connected to an anchor;

FIG. 2 illustrates safe zones set in existing anchor monitoring systems;

FIG. 3 is a schematic flow diagram of a method according to the present invention;

FIG. 4 is a schematic block diagram of an apparatus according to the present invention; and

FIG. 5 illustrates a safe zone that may be set in the present invention.

### DETAILED DESCRIPTION

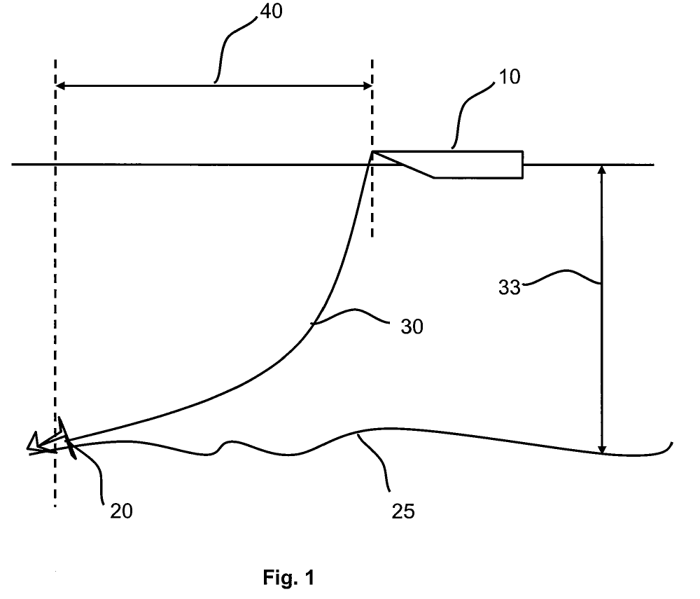

FIG. 1 illustrates a marine vessel 10 connected to an anchor 20 by rode 30. The anchor 20 is set in the seabed 25. Due to wind and tide forces on the marine vessel 10, the vessel 10 is positioned at a horizontal distance 40 from the anchor 20. The water in which the vessel is anchored has a depth 33.

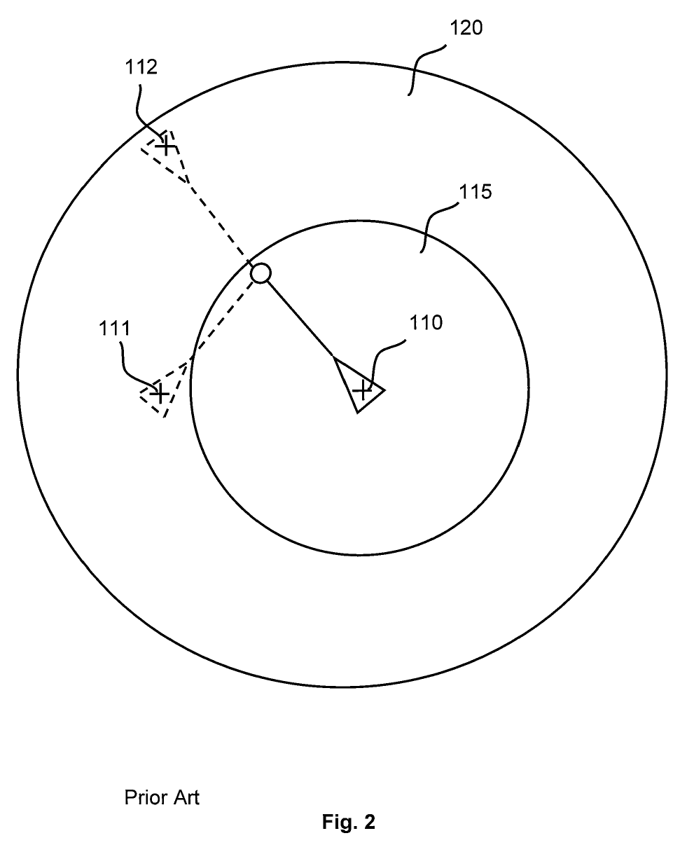

FIG. 2 illustrates a top view of the vessel 10 connected to the anchor 20 by the rode 30. In an existing anchor monitoring systems, a safe zone is set around an initial position 110 of the vessel. A desirable safe zone is relatively small, such as safe zone 115. However, when the vessel 10 swings to position 111 for example, existing anchor monitoring systems would sound an alarm as the vessel 10 is outside the defined safe zone. In order to avoid false alarms caused by the vessel 10 swinging around its anchor 20 due to wind and tide forces, a relatively large safe zone 120 has to be set in order to include position 112.

The inventors have realized that a major shortcoming of existing anchor monitoring systems arises because such systems use the vessel's position as the center of the circular safe zone 115 or 120, rather than the position 113 of the anchor 20 of the vessel 10.

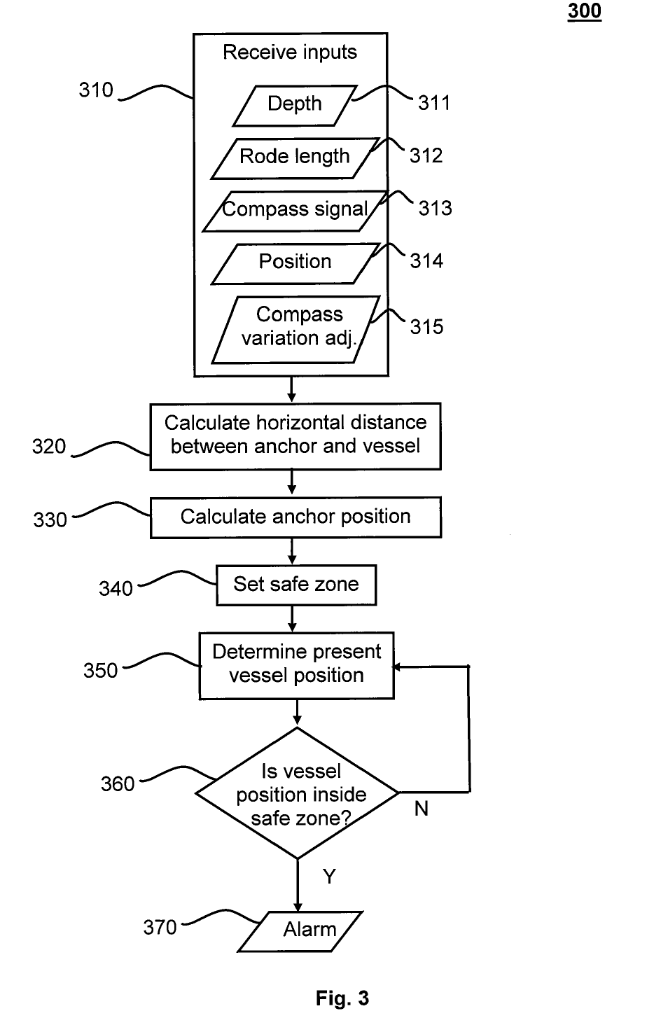

FIG. 3 is a schematic flow diagram of a method 300 of determining, and monitoring a distance traveled by the vessel 10 after the anchor 20 has been set on the seabed 25. In particular, the method 300 determines whether the vessel 10 is dragging its anchor 20, or has broken away from it anchor 20.

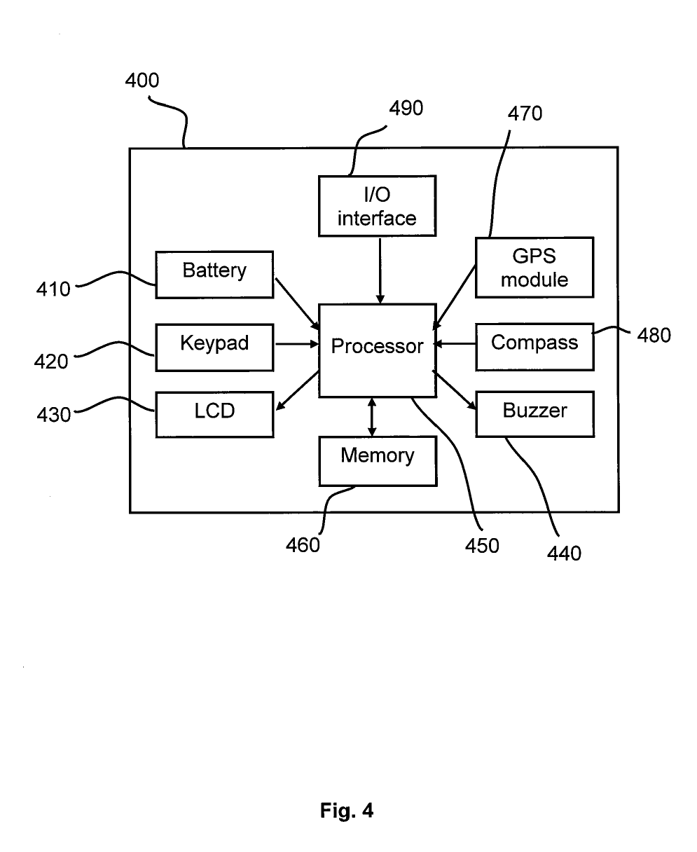

FIG. 4 is a schematic block diagram 400 of an apparatus for implementing method 300. In operation the apparatus 400 would be positioned on, or within the vessel 10. Apparatus 400 includes a power source in the form of a battery 410 and user interfaces including a keypad 420, a liquid crystal display (LCD) 430 and a buzzer 440.

The apparatus 400 further includes a processor 450 and associated memory 460 upon which the method 300 is implemented by means of software instructions. The software instructions may be embedded to the memory 460, or transferred to the memory 460 from another computer readable medium (not illustrated).

The apparatus 400 further includes a global positioning system (GPS) module 470 for determining a present position, and a compass 480 for determining a present orientation. The GPS module 470 uses triangulation from known positions of satellites to calculate the present position of the apparatus 400. Other positioning systems may be employed, such as those based upon triangulation of signals transmitted from land based transmitters.

An input/output (I/O) interface 490 is provided for connecting to external devices (not illustrated). For example, apparatus 400 may be connected to one or more external devices compatible with the National Marine Electronics Association (NMEA) protocol.

Referring again to FIG. 3, the method 300 starts in step 310 where the apparatus 400 receives a number of inputs. These inputs include a water depth value 311, a rode length value 312, a compass signal 313, a position 314 and a compass variation adjustment 315. The compass signal is received from the compass 480, whereas the position 314 is received from the GPS module 470.

The water depth value 311 may be received as input through user interaction with the keypad 420, or directly from a depth sounder (not illustrated) in communication with the apparatus 400 through I/O interface 490. Similarly, the rode length value 312 may be received as user input, or from a transducer (not illustrated) in communication with the apparatus 400 through I/O interface 490, with the transducer being mounted on the vessel 10 and being configured to determine the length of the rode 30 as the rode 30 is let out during anchoring of the vessel 10. The compass variation adjustment 315 may also be received as user input, or alternatively, may be calculated by the processor 450 from the position 314, a geographically applicable Nautical Almanac, local chart or equivalent source.

The method 300 then proceeds to step 320 where processor 450 calculates the horizontal distance 40 between the anchor 20 and the vessel 10 by trigonometric methods using the rode length value 312 and water depth value 311.

Step 330 follows where processor 450 determines the anchor position using the horizontal distance 40 between the vessel 10 and anchor 20, the compass signal 313, the compass variation adjustment 315 and the position 314.

In step 340 a safe zone is set. The safe zone is defined by the anchor position at the centre of a circular zone, and the radius is defined by the horizontal distance 40 plus a predefined tolerance range. The tolerance range is preferably determined, and input into the apparatus 400 based upon factors including tidal variations, wind and vessel characteristics.

A present position is determined in step 350. In step 360 the processor 450 determines whether the present position is inside the safe zone set in step 340. If it is determined that the present position is still inside the safe zone, then the method 300 returns to step 350. However, if it is determined that the present position is no longer inside the safe zone, the vessel has moved outside the set circular safe zone, and the method 300 proceeds to step 370 where an alarm is initiated by sounding the buzzer 440. Optionally the LCD 430 may also display information relating to the heading and distance traveled outside the safe zone.

Apparatus 400 thus alerts the vessel operator through the alarm that the vessel has broken loose from its anchor 20, or that the anchor 20 is not holding.

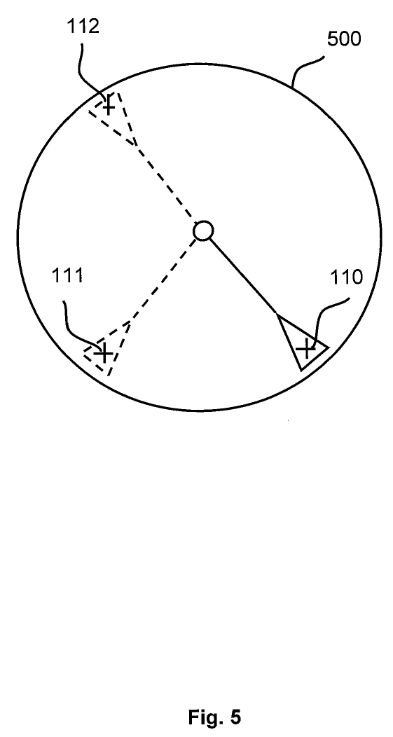

FIG. 5 illustrates a safe zone 500 that may be set in the present invention. The position of the anchor 20 defines the center of the circular safe zone 500. Any position 110, 111, and 112 within the swinging radius of the vessel 10 falls within the safe zone 500. Also, comparing zone 500 with zone 120 of FIG. 120, it can be seen that the present invention allows for a significantly smaller safe zone to be defined.

An advantage of the present invention is that the instances of false alarms caused by tide and wind changes should be reduced.

Aspects of the present invention have been described by way of example only and it should be appreciated that modifications and additions may be made thereto without departing from the scope thereof as defined in the appended claims.

For example, even though the invention has been described with reference to an anchored marine vessel, those skilled in the art would recognize that the present invention may equally be applied to other objects anchored or moored.

1. A method of monitoring the position of a floating object, said method comprising the steps of:
i) receiving as input at least a position of said floating object, and an orientation of said floating object;
ii) calculating a horizontal distance between said floating object and an anchor, said anchor being coupled to said floating object;
iii) calculating a position of said anchor from said position of said floating object and said orientation;
iv) setting an area based upon said position of said anchor;
v) determining whether a present position of said floating object is within said area; and
vi) providing an alarm signal when said present position of said floating object is outside said area.

2. A method as claimed in claim 1, wherein said position of said floating object and said signal present position of said floating object are determined by means of a positioning system.

3. A method as claimed in claim 1 wherein said horizontal distance between said floating object and said anchor is determined from rode length and water depth inputs.

4. A method as claimed in claim 1, wherein said orientation is determined from at least a compass signal.

5. A method as claimed in claim 1, wherein said area is a circular area with the center of said area being defined by said position of said anchor.

6. Apparatus for monitoring the position of a floating object, said apparatus comprising:
means for receiving as input at least a position of said floating object, and an orientation of said floating object;
means for calculating a horizontal distance between said floating object and an anchor, said anchor being coupled to said floating object;
means for calculating a position of said anchor from said position of said floating object and said orientation;
means for setting an area based upon said position of said anchor;
means for determining whether a present position of said floating object is within said area; and
means for providing an alarm signal when said present position of said floating object is outside said area.

7. A computer readable medium, having recorded thereon a computer executable program for implementing a method of monitoring the position of a floating object, said method comprising the steps of:
i) receiving as input at least a position of said floating object, and an orientation of said floating object;
ii) calculating a horizontal distance between said floating object and an anchor, said anchor being coupled to said floating object;
iii) calculating a position of said anchor from said position of said floating object and said orientation;
iv) setting an area based upon said position of said anchor;
v) determining whether a present position of said floating object is within said area; and
vi) providing an alarm signal when said present position of said floating object is outside said area.

7. (canceled)

8. (canceled)
